(19) United States
(12) Patent Application Publication
(10) Pub. No.: US 2006/0021920 A1
(43) Pub. Date: Feb. 2, 2006

(54) Pond filters

(76) Inventors: Robert C. Forbes, Sun Valley, CA (US); Brett Thompson, Westchester, CA (US); Miguel A. Larios, Castaic, CA (US)

Correspondence Address: CHRISTIE, PARKER & HALE, LLP, PO BOX 7068, PASADENA, CA, 91109-7068, US

(21) Appl. No.: 11/078,838

(22) Filed: Mar. 10, 2005

Related U.S. Application Data
(60) Provisional application No. 60/592,611, filed on Aug. 2, 2004.

(51) Int. Cl. B01D 24/46

(52) U.S. Cl. 210/108; 210/420; 210/422; 210/455; 210/427

(57) ABSTRACT

Pond filters are generally discussed herein with particular discussions extended to pond filters having a filter mode and a backflush mode. In accordance with aspects of the present invention, the pond filters incorporate a flow controller positioned inside a housing capable of being manipulated using a control knob located on the outside of the housing. The control knob moves a flow gate to direct incoming fluid flow to flow along a first direction for filtering or a second direction for backflushing the filter cartridge.

### CROSS-REFERENCE TO RELATED APPLICATION

This is an ordinary application of Provisional Application No. 60/592,611, filed Aug. 2, 2004, the contents of which are expressly incorporated herein by reference.

Pond filters are generally discussed herein with particular discussions extended to pond filters having a filter mode and a backflush mode.

### BACKGROUND

The present invention relates to the field of pond filters. Ponds accumulate and generate a variety of contaminants. The exposed surface of the pond is subject to dust accumulation. Organisms living inside the pond create waste. Debris finds its way into the pond over time. All of these circumstances can negatively affect the appearance and cleanliness of the pond. Use of a pond filter is advantageous in maintaining the appearance and health of the pond.

Pond filters are known in the art. In general, pond filters comprise an intake valve and an intake port through which pond water is pumped. The water is filtered of solid debris by passing through a screen. After passing through the screen, the water can be further filtered in order to remove biological contaminants. After the filtering process is complete, the filtered water leaves the filter by way of a discharge port.

Over time, debris collects on an outer surface of the screen. This accumulation of debris hampers the filtering process by limiting the amount of water that can pass through the filter. Processes for removing the debris from the screen of the pond filter are known. For example, the filter can be opened and the screen removed, whereupon it can be cleaned or replaced. Alternatively, the flow of water through the screen can be reversed, loosening the debris and opening a port out of which the debris can be flushed. This process is referred to in the art as “backflushing.”

While pond filters have been around for many years, there exist shortcomings in the prior art that are addressed by the current invention. For example, removing the screen from a pond filter can be a labor intensive process. Replacing a screen can be costly. Backflushing the filter resolves these disadvantages, but presents problems of its own. For example, debris can become imbedded into the screen of the pond filter such that the reverse flow of water during backflushing does not generate sufficient force to remove it. Further, the ports may need to be reversed in order to allow the debris to flow out of the pond filter.

Accordingly, there is a need for a pond filter that contains a mechanism to ensure that the screen becomes free of debris during backflush of the pond filter. There is a further need for a pond filter which requires minimal reconfiguration in order to backflush the filter.

### SUMMARY

The present invention specifically addresses the prior art deficiencies described above. More particularly, the present invention may be implemented by providing a pond filter comprising a housing comprising two or more housing parts attached to one another by one or more clamps, an inlet port; an outlet port, and a backflush port projecting from at least one of the two or more housing parts; a filter cartridge positioned in an interior cavity of the housing having a shaft connected at one end to a control knob and at another end to a plug; wherein the pond filter comprises a filter mode and a backflush mode and is placed in backflush mode or filter mode by manipulating the control knob.

The present invention may also be practiced by providing a pond filter comprising a housing comprising two or more housing parts attached to one another by one or more clamps; an inlet port, an outlet port, and a backflush port projecting from at least one of the two or more housing parts; a filter cartridge positioned in an interior cavity of the housing, said filter cartridge comprising an outer screen having a plurality of openings of a first general dimension and an inner core comprising a plurality of openings of a second general dimension larger than the first general dimension, and a support member for supporting the filter cartridge inside the interior cavity of the housing.

In yet other aspects of the present invention, there is provided a pond filter comprising a housing comprising a first housing part connected to a second housing part along a seam by an adjustable clamp; an outlet port and a backflush port projecting from the first housing part and an inlet port projecting from the second housing part; a filter cartridge comprising an outer main screen and an inner secondary screen positioned in an interior cavity defined by the housing, said filter cartridge comprising two filter stub ends mechanically coupled to two bearing support flanges located on the first and second housing parts; and means for directing fluid flow through the housing between a filter mode and a backflush mode.

Other aspects and variations of the apparatus and method summarized above for the pond filter are also contemplated and will be more fully understood when considered with respect to the following disclosure.

### BRIEF DESCRIPTION OF THE DRAWINGS

Features and advantages of the present invention will become appreciated as the same become better understood with reference to the specification, claims and appended drawings wherein:

FIG. 1 is a semi-schematic perspective view of a pond filter provided in accordance with aspects of the present invention;

FIG. 2 is a semi-schematic perspective view of the pond filter of FIG. 1 with a portion of the filter housing removed;

FIG. 3 is a semi-schematic side view of a first housing part;

FIG. 4 is a semi-schematic end view of the first housing part of FIG. 3 taken along line F3-F3;

FIG. 5 is a semi-schematic front view of a cleaning brush provided in accordance with aspects of the present invention;

FIG. 5A is a semi-schematic end view of the cleaning brush of FIG. 5;

FIG. 6 is a semi-schematic top view of a bearing component provided in accordance with aspects of the present invention;

FIG. 7 is a semi-schematic side view of a second housing part provided in accordance with aspects of the present invention;

FIG. 8 is an end view of the second housing part of FIG. 7 taken along line F8-F8;

FIG. 9 is a semi-schematic transparent side view of the pond filter of FIG. 1 shown with the control knob in a backflush mode;

FIG. 10 is a semi-schematic top view of a ported bearing provided in accordance with aspects of the present invention comprising two cut-outs;

FIG. 11 is a side view of the ported bearing of FIG. 10 taken along line F11-F11;

FIG. 11A is a semi-schematic side view of an insert element provided in accordance with aspects of the present invention;

FIG. 12 is an end view of the ported bearing of FIG. 11 taken along line F12-F12;

FIG. 13 a semi-schematic front view of a flow duct provided in accordance with aspects of the present invention;

FIG. 14 is a side view of the flow duct of FIG. 13 taken along line F14-F14;

FIG. 15 is a semi-schematic top view of a flow gate provided in accordance with aspects of the present invention;

FIG. 16 is an end view of the flow gate of FIG. 15 taken along line F16-F16;

FIG. 17 is a semi-schematic side view of a shaft provided in accordance with aspects of the present invention;

FIG. 18 is a semi-schematic transparent side view of a filter cartridge provided in accordance with aspects of the present invention;

FIG. 19 is an end view of the filter cartridge of FIG. 18 taken along line F19-F019;

FIG. 20 is a semi-schematic end view of a combination plug and rotary device provided in accordance with aspects of the present invention;

FIG. 21 is a side view of the cage of FIG. 20 taken along line F21-F21;

FIG. 22 is a side view of the cage of FIG. 21 taken along line F22-F22;

FIG. 23 is a semi-schematic front view of a plug device provided in accordance with aspects of the present invention;

FIG. 24 is a semi-schematic side view of a center wall for optional use with the filter cartridge provided in accordance with aspects of the present invention;

FIG. 25 is a semi-schematic side view of a clamp for clamping the housing parts together provided in accordance with aspects of the present invention;

FIG. 26 is a semi-schematic back view of a control knob provided in accordance with aspects of the present invention;

FIG. 27 is a semi-schematic front view of the control knob of FIG. 26

FIG. 28 is a semi-schematic perspective view of an alternative cage provided in accordance with aspects of the present invention; and

FIG. 29 is a semi-schematic perspective view of an alternative plug provided in accordance with aspects of the present invention.

### DETAILED DESCRIPTION

The detailed description set forth below in connection with the appended drawings is intended as a description of the presently preferred pond filter provided in accordance with aspects of the present invention and is not intended to represent the only forms in which the present invention may be constructed or utilized. The description sets forth the features and the steps for constructing and using the pond filter of the present invention in connection with the illustrated embodiments. It is to be understood, however, that the same or equivalent functions and structures may be accomplished by different embodiments that are also intended to be encompassed within the spirit and scope of the invention.

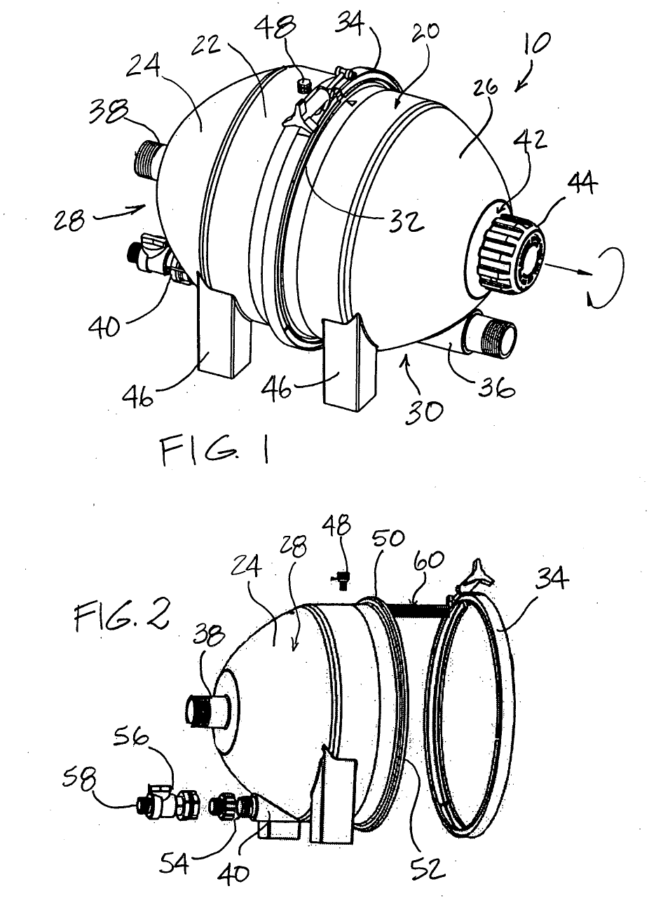

FIG. 1 is a semi-schematic perspective view of a pond filter 10 provided in accordance with aspects of the present invention. The pond filter 10 comprises a housing 20 having an egg shape or ellipse configuration and comprises a cylindrical shape mid-section 22 with two partial spherical shape ends 24, 26. In one exemplary embodiment, the housing 20 is formed from two assembled parts, a first housing part 28, a second housing part 30, which has a seam 32 therebetween defined along a circumference of the cylinder shape mid-section 22. In one exemplary embodiment, the two housing parts 28, 30 are mechanically secured together along the seam 32 by a V-clamp 34, as further discussed below.

In an alternative embodiment, the housing 20 comprises more than two housing parts, for example, a first housing part, a second housing part, and a middle housing connector in between. This alternative housing comprises two seams defined along the circumference of the cylinder shape at different locations and are held together by two V-clamps. However, the number of housing sections can vary and is consider a simple design choice.

In one exemplary embodiment, the pond filter 10 comprises an inlet port 36, an outlet port 38, a backflush port 40, and a flow controller 42 comprising a control knob 44. As further discussed below, the pond filter 10 operates by connecting the inlet port 36 and the outlet port 38 to an appropriate inlet line and discharge line (not shown) and setting the flow controller 42 to filter mode, which comprises manipulating the control knob 44 into the filter position shown. Raw input is then introduced through the inlet port 36, is directed through one or more filter mediums positioned inside the housing (not shown, further discussed below), and then directed out of the discharge port 38. To operate the pond filter 10 in backflush mode, such as when fluid flow is restricted or decreased by obstructions formed around the one or more filter mediums, the flow controller 42 is moved to a backflush mode position. In the backflush mode position, raw inlet flows through the inlet port 36, is directed through a central region of one of the filter mediums, flows through at least one of the filter mediums, and then is directed out through the backflush port 40.

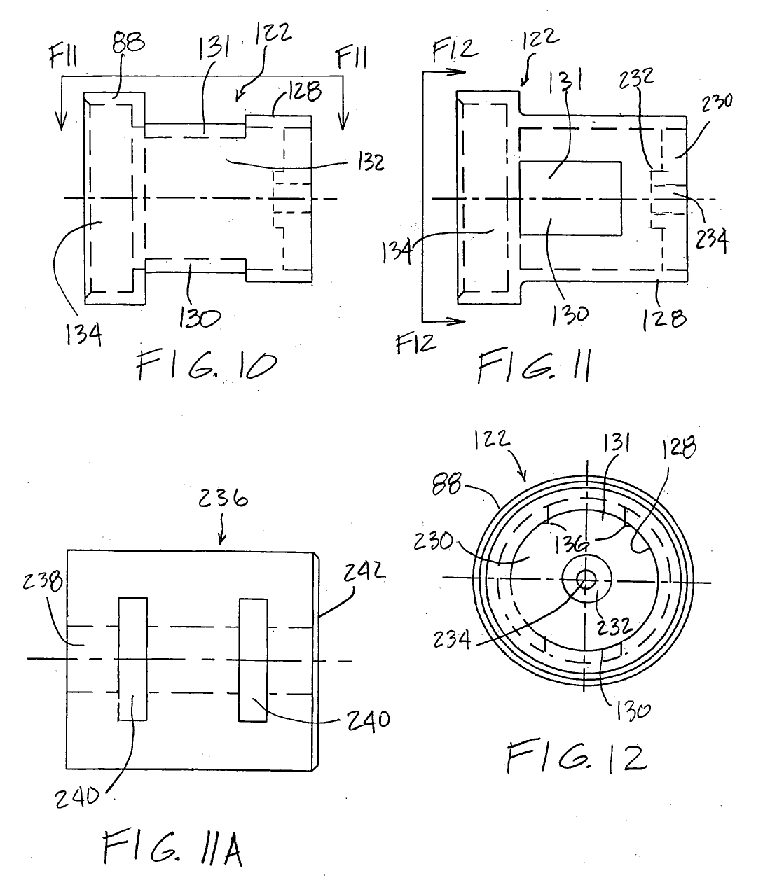

Also shown in FIG. 1 is a plurality of support legs 46 and a vent port 48. Preferably, four spaced apart legs are integrally formed to the housing 20 for supporting the housing in an upright position. Alternatively, two saddles with a flat base may be used instead of four individual legs. In an alternative embodiment, the legs 46 may be separately attached to the housing using glue or welding. The vent port 48 is preferably positioned at a highest point on the housing for venting trapped air when placing the pond filter 10 in operation. In one exemplary embodiment, the vent port 48 comprises a tapped opening and a threaded plug located on the first housing part 28. Alternatively, the vent port 48 may comprise a threaded stub end welded or glue to a drilled hole with a threaded plug positioned at a different high point on the housing 20, such as that shown in FIGS. 7 and 9.

Referring now to FIG. 2, the first housing part 28 of the housing 20 is shown. In one exemplary embodiment, the first housing part 28 comprises a protruding ridge 50 at an opening end 52 of the housing part. The protruding ridge 50 comprises a generally flat mating surface for mating contact with a corresponding surface on the protruding ridge of the second housing part 30 and a tapered clamped surface for taper locking the two housing parts together with the V-clamp 34. The seam 32 is formed where the protruding ridges of the two housing parts 28, 30 come together, forming a joint protruding ridge. In one exemplary embodiment, a groove is incorporated on one of the generally flat mating surfaces of the protruding ridge 50 on the first housing part 28 or the second housing part to receive an O-ring.

In a preferred embodiment, the protruding ridge 50, the outlet port 38, and the backflush port 40 are integrally formed to the first housing part 28. However, the various components may be separately formed and subsequently attached to the first housing part by way of adhesive or welding. The outlet port 38 and the backflush port 40 preferably incorporate standard threads for threaded engagement with downstream fittings. For example, the backflush port 40 is shown attached to a threaded coupling 54, a hand valve 56, which may be a ball valve, a gate valve, or any number of commercially available prior art block valves, and a threaded nipple 58, which is for connecting to a backflush line or a pipe header (not shown).

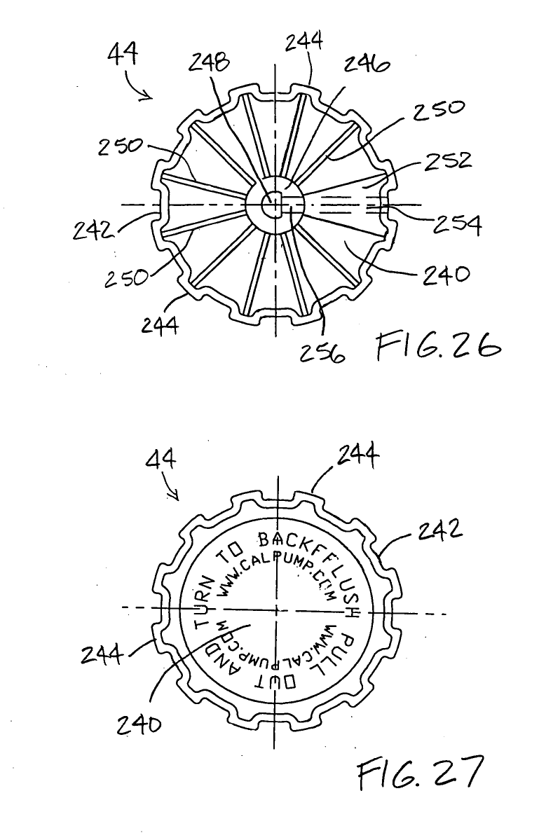

Also shown in FIG. 2 is a V-clamp 32 and a cleaning brush 60. In one exemplary embodiment, the V-clamp 34 is similarly constructed as a hose clamp except a V-shape race is incorporated for taper locking the protruding ridges of the two housing parts 28, 30. More preferably, the V-shape race comprises two tapered walls and a flat surface at the apex of the V, which resembles a truncated V. For facilitating assembly and disassembly, the V-clamp 34 comprises two or more clamp sections connected together by a metallic band, using rivets or tack welding. Preferably, three clamp sections made of sufficiently thick 304 stainless steel grade material attached to a stainless steel band are used to form the V-clamp. An adjustable locking mechanism, comprising a receiving end an adjustment end, is positioned at the two ends of the stainless steel band for adjusting the tension of the V-clamp 34 around the protruding ridges 50 of the two housing parts. When mounted, the V-clamp 34 covers the joint protruding ridge of the two housing parts 28, 30 and encircles the housing 20 along the seam 32 formed by the two protruding ridges. The V-clamp is further discussed below with reference to FIG. 25.

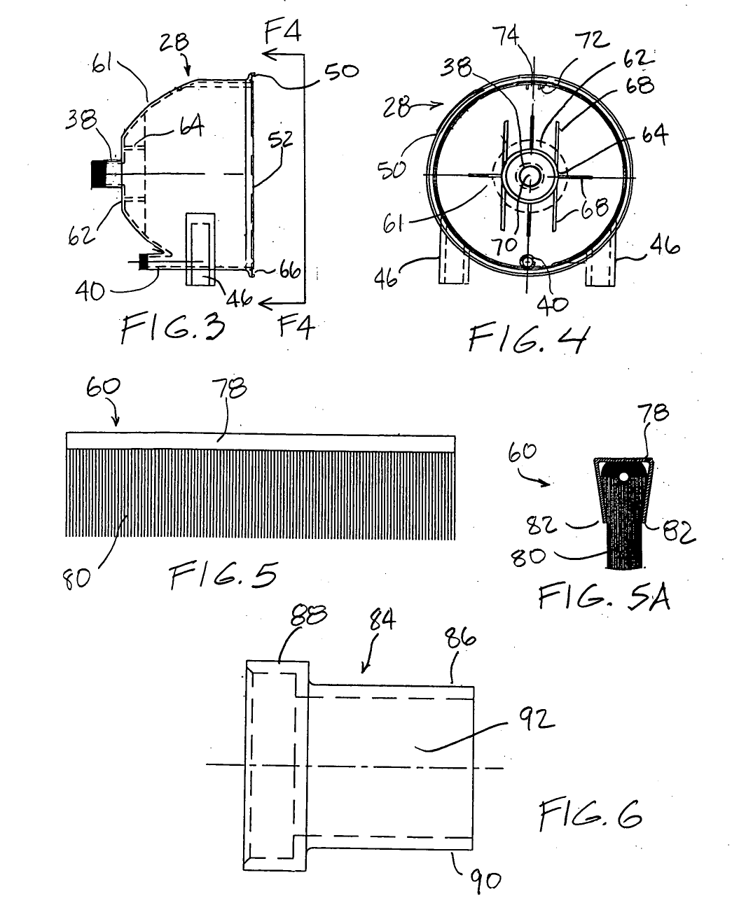

FIG. 3 is a semi-schematic side view of the first housing part 28 with hidden features shown in dashed lines. The first housing part 28 comprises a dome section 61 and a truncated dome end 62 comprising a generally flat surface. The outlet port 38 is integrally molded to the flat surface 62 on one side of the flat surface and a generally cylindrical bearing race or bearing mounting flange 64 for receiving a bearing on the other side of the flat surface. The bearing race 64 is in fluid communication with the outlet port 38 and is adapted to receive a bearing (not shown) for carrying the load of one side of the filter medium (not shown), as further discussed below. Just below the outlet port 38 is the backflush port 40 and two support legs 46, one shown superimposed on the other. At the opposite end of the flat surface 62 on the first housing part 28 is the open end 52 and the protruding ridge 50. As previously discussed, the protruding ridge incorporates a groove 66 for receiving an O-ring (not shown).

FIG. 4 is a semi-schematic end-view of the first housing part 28 shown in FIG. 3 taken along line F4-F4. A plurality of reinforcing ribs 68 are attached to the dome section 61, to the flat end surface 62 of the first housing part 28, and to the bearing race 64. In a preferred embodiment, eight reinforcing ribs are incorporated for reinforcing the bearing race 64. However, fewer or more ribs may be incorporated provided structural integrity of the bearing race and the first housing part 28 are taken into consideration. Also shown at the central region of the bearing race 64 is an opening 70 on the flat end surface 62 leading to the outlet port 38.

In one exemplary embodiment, a mounting bracket 72 and a vapor barrier 74 are incorporated on an upper interior surface of the first housing part 28. The mounting bracket 72 and the vapor barrier 74 may comprise ribs extending along an axial direction along the upper interior surface of the first housing part. The vent port 48 is located between two ribs defining the vapor barrier 74. One of the two ribs forming the vapor barrier 74 also serves as one of two ribs forming the mounting bracket 72 defining a brush channel for receiving a cleaning brush, as further discussed below. The ribs forming the mounting bracket 72 are used to grip the cleaning brush 60 for brushing the filter cartridge, as further discussed below. Preferably, the ribs for holding the cleaning brush 60 each incorporates a projection or lip for engaging the cleaning brush in a detent engagement, as further discussed below.

FIG. 5 is a semi-schematic side view of an exemplary cleaning brush 60 provided in accordance with aspects of the present invention. In one exemplary embodiment, the cleaning brush 60 comprises a backing 78, which may be made from stainless steel, and a plurality of bristles 80, which may be made from 0.004 to 0.01 polypropylene strands. However, other diameter bristles may be incorporated without deviating from the spirit and scope of the present invention. FIG. 5A is a partial semi-schematic end view of the cleaning brush 60 of FIG. 5, showing a detailed view of the backing 78 and the bristles 80. The cleaning brush 76 may be installed on the first housing part 28 by sliding the backing 78 between the two ribs forming the mounting bracket 72 (FIG. 4) and registering the edges 82 of the backing 78 with the projection or lip on each of the ribs of the mounting bracket 72.

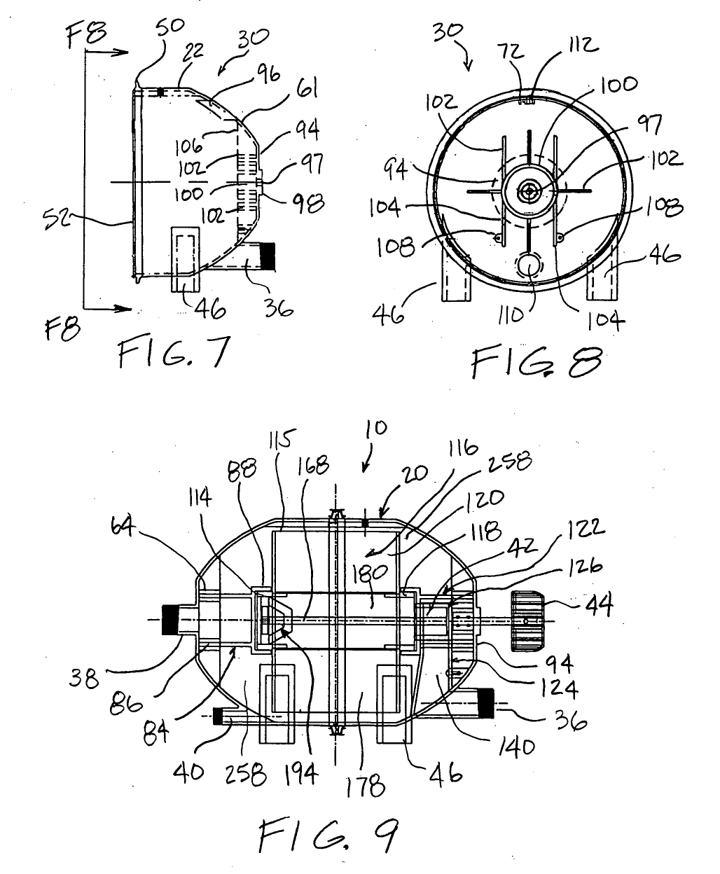

FIG. 6 is a semi-schematic side view of a bearing 84 provided in accordance with aspects of the present invention with hidden interior contour shown in dashed lines. In one exemplary embodiment, the bearing 84 comprises cylindrical mounting end 86 and a cylindrical support end 88. Both ends have an interior surface and an exterior surface defined by an interior ID and an exterior OD. The bearing may be made from an ABS material and preferably of a grayish color.

In one exemplary embodiment, an end section 90 of the mounting end 86 is configured to be inserted into the bearing race 64 (FIGS. 3 and 4) of the first housing part 28 so that the exterior OD of the bearing 84, at least in part, is in abutting relationship with the interior surface of the bearing race 64 of the first housing part 28. Once mounted, the bearing 84 is preferably screw mounted to the bearing race 64 for a secured fit. Alternatively or in addition thereto, the two components may incorporate an interference fit and/or adhesive. As further discussed below, the ID of the bearing support end 88 is configured to accommodate one end of a filter medium to provide both static support and dynamic/rotational support for the filter medium. The bearing 84 defines a passage 92 for fluid flow flowing from the filter medium through the bearing support end 88, through the mounting end 86, and then out the outlet port 38.

FIG. 7 is a semi-schematic side view of the second housing part 30 with hidden features shown in dashed lines. Like the first housing part 28, the second housing part 30 comprises a generally cylindrical section 22, a protruding ridge 50 at the open end 52, two support legs 46 (shown with one superimposed on another), a dome section 61, and a truncated end surface comprising a flat end face 94. The second housing part 30 also comprises an integrally formed inlet port 36 as previously discussed and an optional identification space 96 for molding in a product and/or a company identifier.

In one exemplary embodiment, the exterior surface of the flat end face 94 comprises an integrally formed stub 98, which acts as a spacer for the control knob 44, as further discussed below. A small diameter opening 97 is disposed centrally of the stub 98 for receiving a shaft, as further discussed below. Interiorly, a bearing race 100 and a plurality of ribs 102 are disposed on the interior surface of the flat end face 94. Referring now to FIG. 8 in addition to FIG. 7, the bearing race 100 is shown concentric with the opening 97. A plurality of ribs 102 are attached to the bearing race 100 to reinforce the bearing race and include three lower ribs comprising two end mounting ribs 104. The bearing race 100 and the ribs 102, including the three lower ribs, extend axially away from the end face 94 and terminate along a substantially straight line 106 (show in FIG. 7 as dashed lines adjacent the bearing race 100). The substantially straight line 106 allows the flow controller 42 (not shown, discussed further below) to be mounted thereto and fixedly secured to the second housing part 30 using fasteners to fasten against the integrally formed bosses 108 adjacent the two mounting ribs 104.

Below the bearing race 100 and disposed between the two support legs 46 is an inlet opening 110 leading to the inlet port 36. Above the bearing race 100 is a matching mounting bracket or brush channel 72 for holding the cleaning brush 60. However, rather than incorporating a matching gas barrier 74 (FIG. 4), in one exemplary embodiment, the second housing part 30 incorporates an elongated bar 112, which may be separately fastened to the housing part but is preferably integrally formed thereto. The elongated bar 112 acts as an alignment member and extends or projects axially away from the open end edge 52 of the second housing part 30 and is configured to project into and mate with the gap defined by the two ribs of the gas barrier 74 located on the first housing part 28. When the first housing part 28 is mated with the second housing part 30, the combination elongated bar 112 and the gas barrier 74 facilitates aligning the two housing parts to one another.

FIG. 9 is a semi-schematic transparent side view of the pond filter 10 of FIG. 1 shown assembled and transparent to show the mounting positions of the various components. Viewing from the outlet port 38 towards the control knob 44, the bearing 84 is mounted to the bearing race 64 and is coupled to a filter stub end 114 located at the first end 115 of the filter cartridge 116. A second filter stub end 118 at the second end 120 of the filter cartridge 116 is coupled to a flow controller 42, which comprises a ported bearing 122, a flow duct 124, and a flow gate 126. Aspects of the flow controller 42 are further discussed below and generally speaking are configured to regulate flow for the pond filter 10 between two different modes, a filter mode and a backflush mode. The flow controller 42 is moved between the two modes by manipulating the control knob 44.

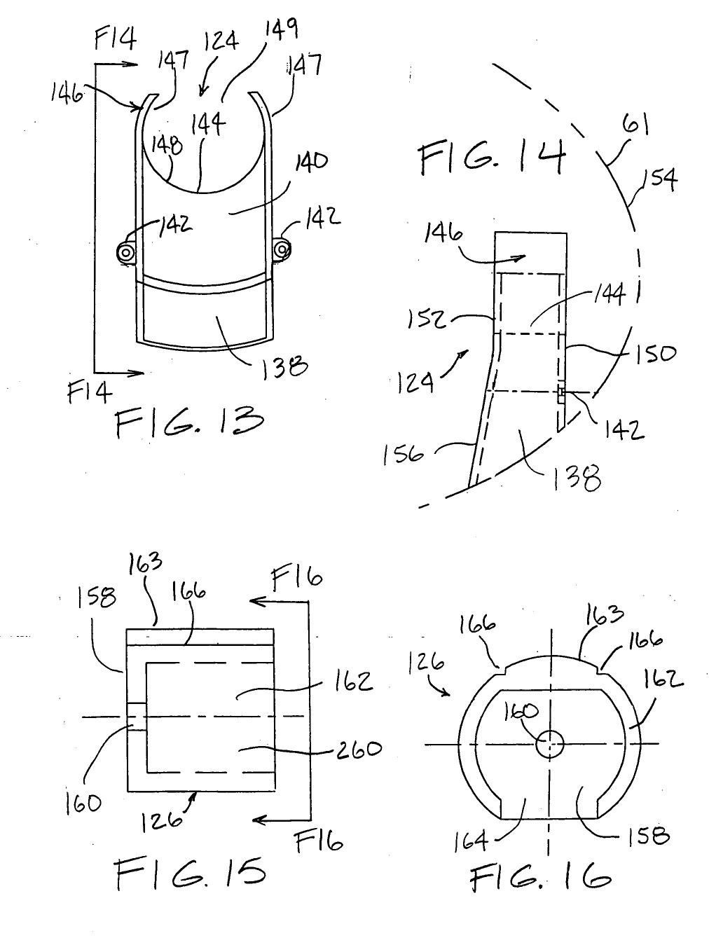

Referring now to FIGS. 10-16, various parts of the flow controller 42 are shown, which include the ported bearing 122 (FIGS. 10-12), the flow duct 124 (FIGS. 13-14), and the flow gate 126 (FIGS. 15-16). Referring initially to FIGS. 10-12 in addition to FIG. 9, the ported bearing 122 is similar to the bearing 84 used at the outlet port 38 and comprises a mounting end 128 and a support end 88. In addition, a pair of evenly spaced-apart cut-outs 130, 131 are incorporated on an elongated section 132 of the support end 128. As further discussed below, inlet flow flowing through the inlet port 36 and through the flow duct 124 travels through the lower cut-out 130 and then either through the upper cut-out 131 or through the opening 134 located at the support end 88 of the ported bearing depending on whether the filter is in a filter mode or a backflush mode. In one exemplary embodiment, when the pond filter 10 is in the filter mode, fluid flow flows through the lower cut-out 130 then through the upper cut-out 131. However, when the pond filter 10 is in a backflush mode, fluid flow flows through the lower cut-out 130 then through the opening 134 at the support end 88 of the ported bearing 122. The upper cut-out 131 will be closed by the flow gate 126 when the pond filter 10 is in backflush mode.

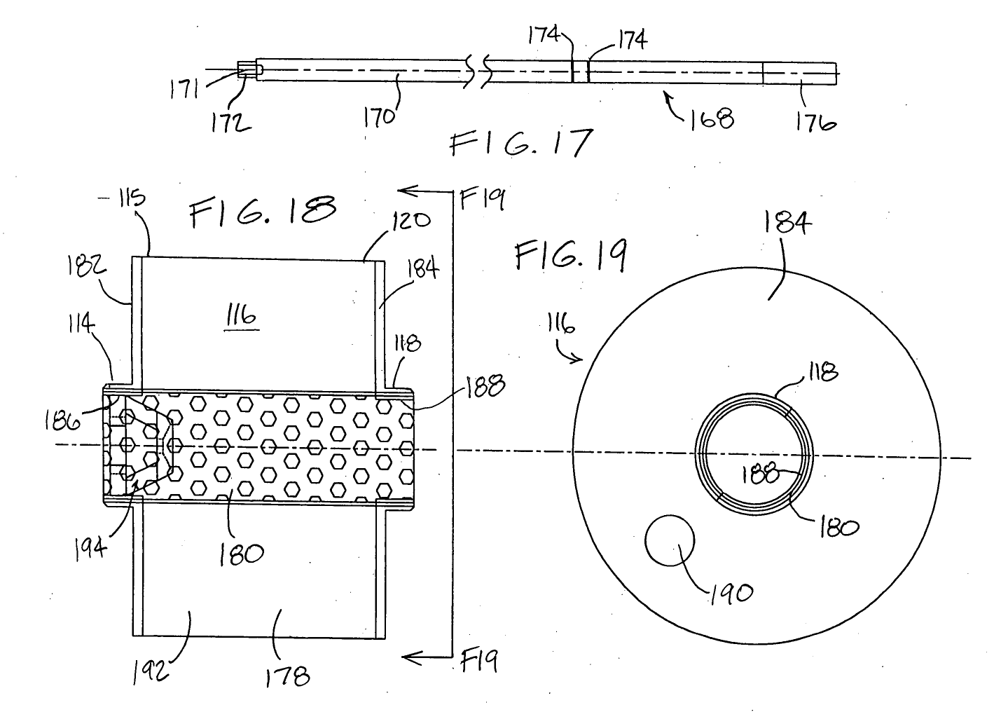

FIG. 11 is a top view of the ported bearing of FIG. 10 taken along line F11-F11. The cut-outs 130, 131, with the upper cut-out being superimposed over the lower, have a generally rectangular projection. However, other shaped projections, such as oval or circular, may be incorporated without deviating from the spirit and scope of the present invention. A bearing end wall 230 comprising a raised stub element 232 comprising a central bore 234 is located at the support end 128 of the ported bearing. The central bore 234 is sufficiently large to receive an insert, such as a brass sleeve bearing or the like. A shaft, discussed further below, is configured to project through the insert element and the central bore 234 of the ported bearing. In a preferred embodiment, the insert element is a brass sleeve bearing comprising grooves for accepting O-rings as well as lubricant or the like. An exemplary insert element 236 is shown in FIG. 11A. The insert element 236 comprises a central bore 238 for receiving a shaft (FIG. 17), grooves 240 for receiving lubricant O-rings as well as lubricant, and an optional chamfer edge 242 to facilitate installation of the insert element 236 in the central bore 234 of the ported bearing 122. In a preferred embodiment, the ported bearing is over-molded to the insert element 236

FIG. 12 is an end view of the ported bearing of FIG. 11 taken along line F12-F12. A pair of notches or male detents 136 are shown positioned proximate the upper cut-out 131. As further discussed below, the pair of notches 136 are configured to mate with corresponding grooves located on the flow gate 126 (FIGS. 15-16) to register the flow gate with to the ported bearing 122. The notches 136 and the corresponding grooves permit the flow gate 126 to translate relative to the ported bearing 122 but not rotate.

FIG. 13 is an exemplary semi-schematic front view of the flow duct 124, as viewed from the perspective of the control knob 44 of FIG. 9, provided in accordance with aspects of the present invention. In one exemplary embodiment, the flow duct 124 comprises a duct inlet 138, a main duct channel 140 comprising a set of ears 142 for attaching the flow duct to the threaded bosses 108 located on the dome section 61 of the second housing part 30, a duct outlet 144, and a holding clamp 146. The holding clamp 146 comprises two arcuate arms 147 and the edge 148 of the duct outlet 144, which together form a semi-circular jaw adapted to receive the mounting end 128 of the ported bearing 122 (FIGS. 10-12). In a preferred embodiment, the holding clamp 146 has a circumference of about 55% to about 85% of that of a circle. The gap 149 in between the two arcuate arms 147 is configured to expose the upper cut-out 131 of the ported bearing 122 for fluid flow out of the upper cut-out 131 during the pond filter mode. With reference to FIG. 14, which is a side view of the flow duct 124 of FIG. 13 taken along line F14-F14, the mounting end 128 of the ported bearing 122 (FIG. 10) should be inserted so that the duct outlet 144, shown in dashed lines, aligns with the lower cut-out 130 of the ported bearing 122 and the two, along with the duct inlet 138, are in fluid communication.

In one exemplary embodiment, the flow duct 124 comprises a front surface 150 and a rear surface 152. When the flow duct 124 is mounted to the second housing part 30, the front surface 150 abuts the edge of the ribs 102 along the edge line 106 (FIG. 7). The flow duct 124 is held in place by using stainless steel fasteners or screws and tightening the same through the set of ears 142 and the threaded bosses 108 (FIG. 8).

The curvature of the second housing part 30 is represented in FIG. 14 with dashed lines of the ellipse shape 154. As the second housing part 30 comprises a dome section 61, the duct inlet 138 is formed such that it conforms to the curvature of the dome section 61. In one exemplary embodiment, this includes adding a flare or taper 156 to the rear surface 152 to conform to the curvature of the dome section 61 and to align the duct inlet 138 with the inlet opening 110 of the inlet port 36 (FIGS. 8-9).

FIG. 15 is a semi-schematic side view of the flow gate 126 provided in accordance with aspects of the present invention. In one exemplary embodiment, the flow gate 126 resembles an enclosed cylindrical section with a few exceptions. It comprises a single end wall 158 comprising a central bore 160 for receiving a shaft and a side wall 162. However, with reference to FIG. 16, the enclosed cylindrical section is truncated so as to form an opening 164 through a section of the side wall 162. This opening 164 is preferably sized to match or correspond with the lower cut-out 130 of the ported bearing 122. Located opposite the opening 164 along an exterior surface is a set of notches 166 for mating contact with the male detents 136 (FIG. 12) on the ported bearing 122, which is the cap section 163 of the side wall 162. Preferably, the wall thickness of the cap section 163 is increased over the wall thickness adjacent the opening 164 and elsewhere on the side wall 162 to add structural integrity for that section of the side wall and to facilitate the construction of the mold.

The flow controller 42 may be assembled by first inserting the mounting end 128 of the ported bearing 122 (FIG. 10) through the holding clamp 146 of the flow duct 124 (FIG. 13) while ensuring that the duct outlet 144 aligns with the lower cut-out 130 of the ported bearing. The mounting end 128 is then inserted into the bearing race 100 of the second housing part 30 (FIG. 8). Preferably, an interference fit is incorporated between the mounting end 128 of the ported bearing and the bearing race 100 with adhesive being optional. Alternatively, screws or fasteners may be used to secure the mounting end 128 to the bearing race 100. Four bosses in a non symmetrical spacing are preferably incorporated for receiving the screws to force alignment between the two components. The flow duct 124 is then fastened to the threaded bosses 108 on the second housing part 30 using fasteners or screws. More preferably, the flow duct 124 is mounted to the second housing part 30 prior to assembling the ported bearing 122.

The flow gate 126 is then inserted into the ported bearing 122 with the end comprising the end wall 158 (FIG. 15) in first. However, before doing so, the flow gate 126 is mounted on a shaft 168, such as that shown in FIG. 17, and the shaft is inserted through the insert element 236 (FIG. 11A) positioned on the bearing wall 230 of the ported bearing 122. In one exemplary embodiment, the shaft 168 comprises a generally cylindrical rod 170 comprising a square end 172 for mating with a plug device (further discussed below), a pair of grooves 174, and a flat end section 176 for mating with the control knob 44. The flat end section 176 resembles a truncated cylindrical rod section comprising a flat surface for abutting with a corresponding truncated bore on the control knob 44, as further discussed below. The rod 170 is inserted through the bore 160 of the flow gate 126 with the flat end section 176 in first. The rod 170 is inserted until the two machined grooves 174 straddle the end wall 158 of the flow gate 126. A pair of slotted washers or e-clips (not shown) may be used to secure the end wall 158 between the machined grooves 174. Once secured, the shaft 170 may rotate relative to the flow gate 126 but not translate. Say differently, the shaft 170 and the flow gate 126 may move together as a unit during translational movement of the shaft but not during rotational movement of the shaft. When the flow gate 126, with the shaft 168 mounted thereto, is inserted into the ported bearing 122 (FIG. 10), the flow gate 126 should be aligned so that the grooves 166 (FIG. 16) on the flow gate register with the male detents 136 (FIG. 12) located in the interior cavity of the ported bearing 122.

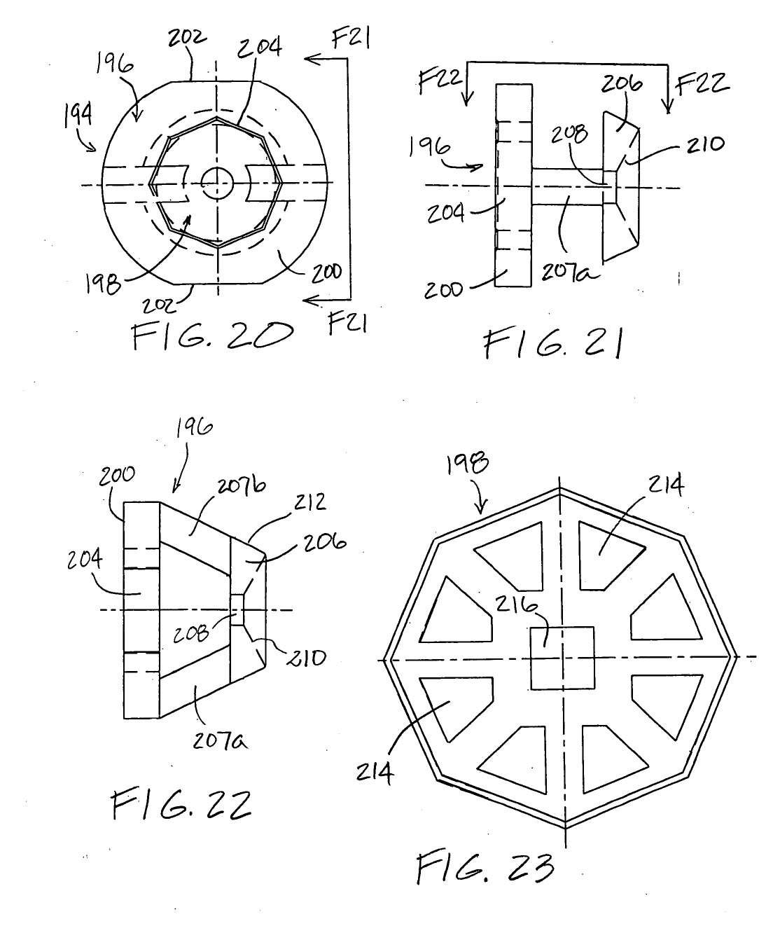

With reference to FIG. 18 in addition to FIG. 9, the filter cartridge 116 is adapted to couple to the flow controller 42. In one exemplary embodiment, the filter cartridge 116 comprises a main screen 178 made from a polypropylene or equivalent material and a secondary screen 180, which in one exemplary embodiment is a perforated PVC pipe. In one exemplary embodiment, the main screen has a mesh size of about 590-825 micron and the perforated holes on the secondary screen 180 each has an opening of about 0.25 to about 0.75 inch with other sizes contemplated provided they are compatible with the size of the bioballs and the matters to be filtered, as further discussed below. The two end walls 182, 184, having the first stub end 114 and the second stub end 118 respectively, and the secondary screen 180 form a frame. The main screen 178 is bonded to the frame, and in particular to the circumferential edge of the two end walls 182, 184, to form the filter cartridge 116. The secondary screen 180 is connected to the two end walls 182, 184 by inserting through the openings of the two stub ends 114, 118 and then securing the same at the two ends with two collars 186, 188. The stub ends 182, 184, the ends of the secondary screen 180, and the two collars 186, 188 may be sealed together by using adhesive. In a preferred embodiment, the secondary screen 180 is inserted into a first mold having a shape of a first end wall 182 (or second end wall 184). Liquid polyurethane, which is preferably cool to the touch, is then pored into this mold. A main screen 178 is then inserted into the liquid polyurethane. In one exemplary embodiment, the main screen 178 is cylindrical having a first length. The length is subsequently cut to a desired second length. The first mold is then heated to cure the polyurethane. Once the polyurethane solidifies, the assembly is removed from the first mold. A second mold having a shape of the second end wall 184 is then charged with liquid polyurethane. The assembly is inverted and inserted into the second mold and then heat cured.

FIG. 19 is a semi-schematic side view of the end wall 184 of the filter cartridge 116 of FIG. 18 taken along line F19-F19. The exterior surface of the stub end 118 comprises an OD adapted to fit within the ID of the support end 88 of the ported bearing 122 (FIG. 10). Preferably, a total clearance of about 040 thousandths is incorporated between the OD of the stub end 118 and the ID of the support end 88. A similar clearance is also incorporated between the OD of the first stub end 114 and the ID of the support end 88 of the first bearing 84 (FIG. 6). A cap 190 is preferably incorporated and is adapted to engage an opening on the end wall 184. When the cap 190 is removed, a cavity 192 defined by the annular space between the main screen 178, the secondary screen 180, and the two end walls 182, 184 is accessible through the opening. A plurality of bioballs may be added in the cavity 192 to act as a biological medium for bacteria growth for biological filtration. Commercially available bioballs are generally larger in dimension that the openings of the various perforations on the secondary screen 180 and therefore should not escape out of the cavity 192 through either the first main screen 178 or the secondary screen 180. In an alternative embodiment, the secondary screen 180 is not incorporated and no bioballs used. A rod or a shaft is instead used in this alternative embodiment to provide support for the filter cartridge.

In an exemplary embodiment, the cap 190 also functions as a relief valve by incorporating a plurality of frangible seals. The frangible seals are designed to separate or sever at a given predetermined pressure. Thus, when the surface of the main screen 178 (FIG. 18) is covered with debris, pressure builds up in the internal cavity 258 of the filter housing 20, which could potentially collapse the main screen. The frangible seals incorporated on the cap 190 would therefore ideally rupture before the main screen collapses. The inexpensive cap can thereafter be replaced without having to replace the entire filter cartridge 116. In an exemplary embodiment, the frangible seals are designed to sever or rupture at approximately 1 psi. However, if the main screen has a higher yield strength, then the frangible seals can be configured to sever at a higher pressure, and vice versa.

A combination plug and rotary device 194 for redirecting fluid flow during backflush and for rotating the filter cartridge 116 is positioned inside the secondary filter 180 at the first stub end 114. In one exemplary embodiment, the combination device 194 fits inside the first stub end 114 using an interference fit. With reference to FIG. 20, the combination device 194 comprises a cage 196 and a multi-sided plug 198. The cage 196 has a semi-circular front flange 200, one or more truncated edges 202, and a multi-sided opening 204 configured to matingly receive the multi-sided plug 198. In one exemplary embodiment, the multi-sided opening 204 and plug 198 comprise an eight-sided configuration (i.e., octagon). However, three (i.e., triangle) or more sided configurations (square, pentagon, hexagon, etc.) may be incorporated without deviating from the spirit and scope of the present invention. As further discussed below, the plug 198 is positioned on the machined end 172 of the shaft 168 (FIG. 17) and is placed in mechanical coupling with the opening 204 of the cage 196 by pulling on the control knob 44 while rotating the control knob to ensure that the multi-sided edges mesh. In an alternative embodiment, the opening 204 may comprise a circular opening having integrally formed coarse threads and the plug 198 comprising a corresponding shape with corresponding coarse threads. The coarse threads replace the function of the multi-sided edges and in addition provide added engagement against de-coupling between the plug and the opening.

FIG. 21 is a semi-schematic side view of the cage of FIG. 20 taken along line F21-F21. In one exemplary embodiment, the cage 196 comprises a front flange 200 comprising the multi-sided opening 204, as previously discussed, and a back flange 206 connected to one another by a pair of connecting bars 207a, 207b, shown with one superimposed on the other. Preferably, the back flange 206 has a same outside dimension as the front flange 200 but more preferably a smaller outside dimension than the front flange. The back flange 206 comprises an opening 208 sized to receive the shaft 168 (FIG. 17). In one exemplary embodiment, a tapered end face 210 is incorporated for facilitating insertion of the shaft 168 into the opening 208 of the back flange 206 when the same is inserted in the direction of the back flange towards the front flange 200.

FIG. 22 is a semi-schematic top view of the cage of FIG. 21 taken along line F22-F22. In one exemplary embodiment, the connecting bars 207a, 207b extend from the perimeter edge of the front flange 200 towards the perimeter edge 212 of the back flange 206. Preferably, the perimeter edge 212 of the back flange 206 is tapered so that the edge of the back flange aligns with the edges of the two connecting bars 207a, 207b.

FIG. 23 is a semi-schematic front view of the multi-sided plug 198 provided in accordance with aspects of the present invention. In one exemplary embodiment, the plug is molded from an ABS or equivalent material and is formed with a plurality of indentations 214 and a square central opening 216. The square opening 216 is configured to receive the machine end 172 of the shaft 168 (FIG. 17) for mounting the plug 198 onto the shaft. A fastener or a screw may then be used to fastened to the threaded boss 171 at the machine end 172 of the shaft 168.

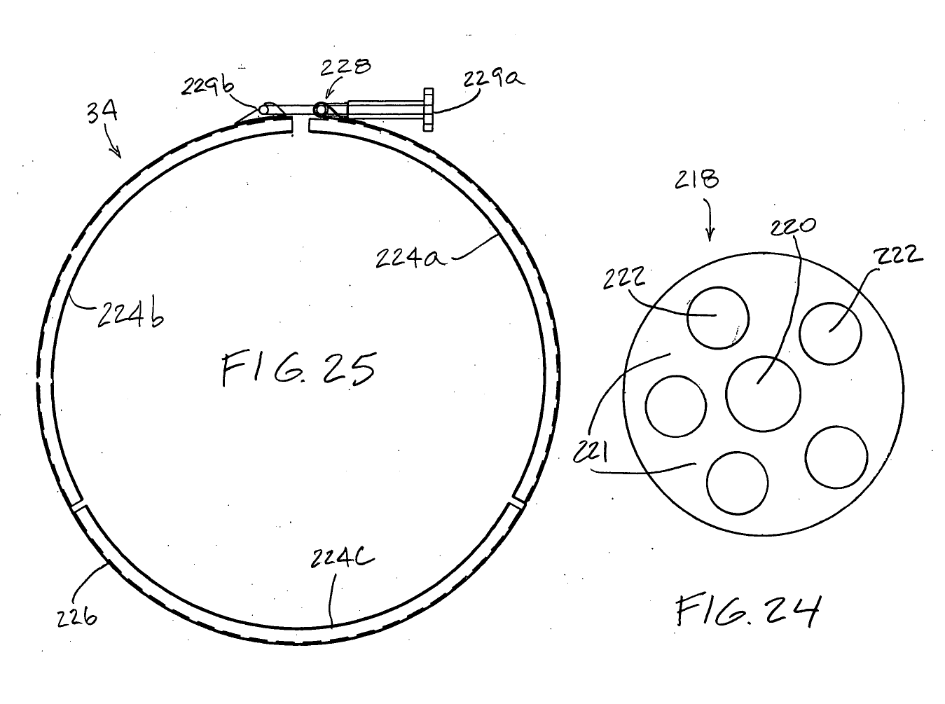

FIG. 24 is a semi-schematic front view of an inner wall 218 provided in accordance with aspects of the present invention. In one exemplary embodiment, the inner wall 218 is used to support the main screen 178 to prevent the same from collapsing when plugged up by debris or other contaminants. When incorporated, the inner wall 218 is positioned between the two end walls 182, 184 of the filter cartridge 116 (FIG. 18) by sliding the central opening 220 over the secondary screen 180 and positioning the inner wall 218 approximately mid-way between the two end walls. A plurality of spokes 221 defining a plurality of openings 222 are provided to permit fluid communication between the two compartments defined by the left end wall 182 and the inner wall 218 and the right end wall 184 and the inner wall. In a preferred embodiment, the inner wall 218 is made from the same material as the end walls and has the same outer dimension as the end walls.

FIG. 25 is a semi-schematic side view of a V-clamp 34 provided in accordance with aspects of the present invention. As previously discussed, the V-clamp comprises two or more clamp sections 224a, 224b, 224c (shown with three) attached to an outer metallic band 226, and comprises an adjustable locking mechanism 228 comprising a receiving end 229a and an adjustment end 229b.

FIG. 26 is a semi-schematic back view of a control knob 44 provided in accordance with aspects of the present invention, which may be made from an ABS material or the like. In one exemplary embodiment, the control knob 44 resembles a cap and comprises a top 242 and a side wall 244 comprising a plurality of raised protrusions 244 for facilitating gripping. A central hub 246 comprising a truncated cylindrical bore 248 is incorporated to receive the flat or machined shaft end 176 of the shaft 168 (FIG. 17). In one exemplary embodiment, a plurality of ribs 250 connect the central hub 246 to the side wall 242 for structural rigidity. A filled solid section 252 comprising a hollow bore 254 in communication with a threaded bore 244 is incorporated for securing the control knob 44 to the shaft 168 using a set screw. FIG. 27 is a semi-schematic front view of the control knob 44 of FIG. 26. In one exemplary embodiment, instructions or the like may be molded into the top surface area 240.

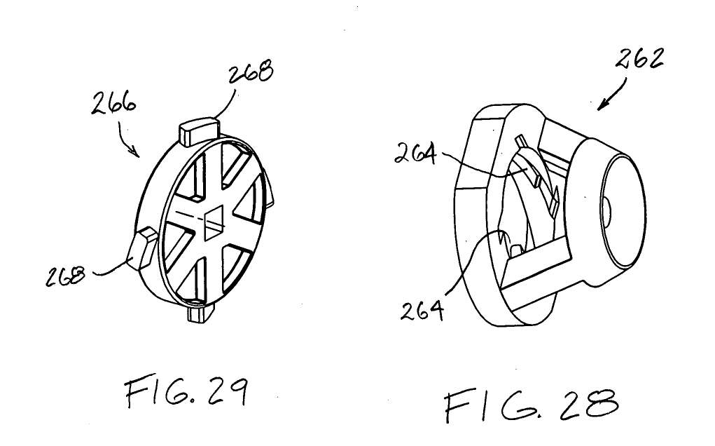

FIG. 28 is a semi-schematic perspective view of a cage 262 provided in accordance with aspects of the present invention comprising coarse threads 264. As previously discussed with reference to the cage 196 of FIGS. 20-22, the coarse threads may be incorporated instead of a multi-sided opening. FIG. 29. is a semi-schematic perspective view of a plug 266 comprising corresponding coarse threads 268.

Referring again to FIG. 9, the pond filter 10 may be placed in the filter mode and allow to filter fluid by manipulating the control knob 44, which comprises pushing the control knob 44 so that it contacts or is placed adjacent the flat end surface 94 of the second housing part 30 (See, e.g., FIG. 1). As the flow gate 126 (FIGS. 15-16) is attached to the shaft 168, when the control knob is pushed, the shaft 168 and the flow gate 126 move in the direction of the outlet port 38. Fluid entering the inlet port 36 will then flow through the main duct channel 140 of the flow duct 124, then through the lower and upper cut-outs 130, 131 of the ported bearing 122 (FIGS. 10-12) and into the interior cavity 258 of the housing 20. As the flow gate 126 is pushed forward, fluid will flow behind the end wall 158 of the flow gate, between the end wall 158 and the bearing wall 230 of the ported bearing (FIG. 10). The vent port 48 (FIG. 1) may be opened to release trapped gas or air and then closed during normal filter operation.

Once fluid flows inside the interior cavity 258 of the housing 20, fluid then travels through the main screen 178 of the filter cartridge 116 and then through the secondary screen 180, where large suspended solids and bacteria will be filtered. The filter fluid then exits the combination device 194 and out through the first bearing 84 and the outlet port 38, which in one exemplary embodiment is connected to a downstream line and then back to the inlet fluid source.

The pond filter 10 may be placed in backflush mode by manipulating the control knob 44 to the position shown in FIG. 9, i.e., by pulling and concurrently turning the control knob 44. The pulling motion moves the shaft 168 and the flow gate 126 (FIGS. 15-16) in the direction of the flat end face 94 (FIG. 7) and moves the cap section 163 of the side wall 162 (FIG. 16) to cover the upper cut-out 131 on the ported bearing 122 (FIG. 10). The turning motion allows the multi-sided plug 198 to mesh with the multi-sided opening 204 on the cage 196 of the combination device 194 (FIGS. 20-22). If coarse threads are instead incorporated, the turning motion engages the threads on the opening 204 with the threads on the plug 198.

Referring again to FIG. 9, during backflush mode, fluid that enters the inlet port 36 flows through the main duct channel 140 of the flow duct 124 then through the lower cut-out 130 of the ported bearing 122, through the side opening 164 of the flow gate 126 then out the axial opening 260 opposite the end wall 158 (FIG. 15) and then through the center of the secondary screen 180. As the combination device 194 is closed, fluid then travels radially outwardly through the perforated holes of the secondary screen 180 and then out through the main screen 178. Either before or after the control knob 44 is manipulated into the backflush mode, the hand valve 56 (FIG. 2) on the backflush port 40 (e.g., FIG. 1) is opened to permit backflush flow. Fluid flowing radially outwardly through the main screen 178 will push debris or other contaminants built-up on the surface of the main screen to peel off the same and flow out through the backflush port 40.

During backflush mode, debris or other contaminants can be further cleaned by rotating the control knob 44. Once the combination device 194 is engaged, further knob rotation causes the filter cartridge 116 to rotate about the axis defined by the shaft 168. Rotational force is generated by the user turning the control knob 44, which turns the plug 198 (FIG. 20), which then turns the cage 196 of the combination device 194. The cage 196 is in turn connected to the filter cartridge 116 and therefore turns the filter cartridge. As the filter cartridge turns, it gets brushed by the cleaning brush 60 (FIGS. 5 and 5A) mounted on the housing 20. After a sufficient period of time, the pond filter 10 may be placed back in the filter mode by pushing on the control knob 44, or by rotating in the opposite direction to unscrew the coarse threads and then subsequently pushing on the control knob 44 in the direction of the outlet port 38.

Although limited preferred embodiments and methods for making and using the pond filters provided in accordance with aspects of the present invention have been specifically described and illustrated, many modifications and variations will be apparent to those skilled in the art. For example, various material changes may be used, incorporating different mechanical engagement means to attach the various components to one another, to manipulate the flow controller, to support the filter cartridge, etc. Accordingly, it is to be understood that the pond filters constructed according to principles of this invention may be embodied other than as specifically described herein. The invention is also defined in the following claims.

What is claimed is:

1. A pond filter comprising a housing comprising two or more housing parts attached to one another by one or more clamps, an inlet port; an outlet port, and a backflush port projecting from at least one of the two or more housing parts; a filter cartridge positioned in an interior cavity of the housing having a shaft connected at one end to a control knob and at another end to a plug; wherein the pond filter comprises a filter mode and a backflush mode and is placed in backflush mode or filter mode by manipulating the control knob.

2. The pond filter of claim 1, wherein the two or more housing parts comprise two housing parts defining a seam comprising an O-ring therebetween.

3. The pond filter of claim 1, wherein the outlet port and the inlet port are positioned on different housing parts.

4. The pond filter of claim 1, further comprising a cage, wherein the plug engages the cage when the ponder filter is in backflush mode.

5. The pond filter of claim 1, wherein the filter cartridge comprises a main filter and a secondary filter.

6. The pond filter of claim 5, further comprising a plurality of bioballs positioned in a space between the main filter and the secondary filter.

7. The pond filter of claim 1, further comprising a flow controller, said flow controller directs fluid flow flowing through the inlet port.

8. The pond filter of claim 7, wherein the flow controller comprises a flow duct, a flow gate, and a ported bearing.

9. The pond filter of claim 1, wherein the filter cartridge comprises two end walls.

10. The pond filter of claim 9, further comprising a cap engaged to an access opening on at least one of the two end walls.

11. A pond filter comprising a housing comprising two or more housing parts attached to one another by one or more clamps; an inlet port, an outlet port, and a backflush port projecting from at least one of the two or more housing parts; a filter cartridge positioned in an interior cavity of the housing, said filter cartridge comprising an outer screen having a plurality of openings of a first general dimension and an inner core comprising a plurality of openings of a second general dimension larger than the first general dimension, and a support member for supporting the filter cartridge inside the interior cavity of the housing.

12. The pond filter of claim 11, wherein the support member comprises two cylindrical member attached to two housing parts.

13. The pond filter of claim 11, further comprising a shaft passing through an axial center of the filter cartridge.

14. The pond filter of claim 13, further comprising a combination cage and plug located at a first end of the shaft and a flow controller at a second end of the shaft.

15. The pond filter of claim 14, wherein the cage comprises course threads and the plug comprises corresponding coarse threads.

16. The pond filter of claim 14, wherein the flow controller comprises a control knob and a flow duct.

17. The pond filter of claim 16, wherein the flow duct directs fluid flow from the inlet port to a flow gate.

18. The pond filter of claim 17, wherein the fluid flow flows through a ported bearing.

19. The pond filter of claim 11, further comprising a plurality of support legs.

20. The pond filter of claim 11, further comprising a vent port.

21. The pond filter of claim 11, further comprising a plurality of bioballs located between a space defined by the outer screen and the inner core.

22. The pond filter of claim 11, further comprising a block valve connected to the backflush port.

23. A pond filter comprising a housing comprising a first housing part connected to a second housing part along a seam by an adjustable clamp; an outlet port and a backflush port projecting from the first housing part and an inlet port projecting from the second housing part; a filter cartridge comprising an outer main screen and an inner secondary screen positioned in an interior cavity defined by the housing, said filter cartridge comprising two filter stub ends mechanically coupled to two bearing support flanges located on the first and second housing parts; and means for directing fluid flow through the housing between a filter mode and a backflush mode.

24. The pond filter of claim 23, wherein the means for directing fluid flow comprises a control knob.

25. The pond filter of claim 24, wherein the means for directing fluid flow further comprises a flow duct, a flow gate, and a ported bearing.

26. The pond filter of claim 25, wherein the ported bearing comprises a plurality of cut-outs for fluid flow.

27. The pond filter of claim 26, wherein the ported bearing comprises a bearing insert element.

28. The pond filter of claim 27, further comprising a shaft projecting through the center of the means for directing fluid flow and the filter cartridge.

29. The pond filter of claim 23, wherein the filter cartridge comprises a first end wall and a second end wall.

30. The pond filter of claim 29, further comprising a cap for capping an opening located on one of the end walls.
